(19) United States
(12) Patent Application Publication
(10) Pub. No.: US 2018/0350155 A1
(43) Pub. Date: Dec. 6, 2018

(54) SYSTEM FOR MANIPULATING A 3D SIMULATION OF A PERSON BY ADJUSTING PHYSICAL CHARACTERISTICS

(71) Applicant: L'OREAL, Paris (FR)

(72) Inventors: Kelsey Norwood, Scotch Plains, NJ (US); Kathryn Zuccarello, Franklin Park, NJ (US); Morteza Haeri, Rahway, NJ (US); Nima Gohil, Cliffwood, NJ (US); Mehdi Doumi, Edison, NJ (US)

(73) Assignee: L'OREAL, Paris (FR)

(21) Appl. No.: 15/994,183

(22) Filed: May 31, 2018

Related U.S. Application Data
(60) Provisional application No. 62/513,118, filed on May 31, 2017.

(51) Int. Cl. G06T 19/20; H04N 13/189; G06T 15/08; G06T 13/40; H04L 29/06

(52) U.S. Cl. CPC G06T 19/20; H04N 13/189; H04L 63/0421; G06T 13/40; G06T 15/08

(57) ABSTRACT

A system including processing circuitry configured to receive a captured image of a user; generate a three-dimensional (3D) image of the user based on the captured image of the user; control display of an interface for receiving a selection or adjustment of a feature on the 3D image from the user; and perform adjustment of the feature on the 3D image based on the received selection or adjustment of the feature of the user to generate an updated 3D image.

### CROSS-REFERENCE TO RELATED APPLICATIONS

This application claims the benefit of priority from U.S. Provisional Application No. 62/513,118 filed May 31, 2017, the entire contents of which are incorporated herein by reference.

### BACKGROUND

### Field

The present disclosure describes a system in which a three-dimensional (3D) avatar is generated based on a selfie image of a user and then selections and adjustments can be made to particular cosmetic features on the 3D avatar.

### SUMMARY

In an embodiment, a system is provided comprising: processing circuitry configured to receive a captured image of a user; generate a three-dimensional (3D) image of the user based on the captured image of the user; control display of an interface for receiving a selection or adjustment of a feature on the 3D image from the user; and perform adjustment of the feature on the 3D image based on the received selection or adjustment of the feature of the user to generate an updated 3D image.

In an embodiment, the feature is a hairstyle of the 3D image of the user, and the processing circuitry controls display of an interface for receiving a selection of a predetermined hairstyle from the user.

In an embodiment, when the predetermined hairstyle is selected by the user, the processing circuitry controls display of an interface for receiving an adjustment of at least one of curl, length, density, and thickness of an appearance of the hair in the selected predetermined hairstyle.

In an embodiment, the feature is one or two eyelashes on the 3D image of the user, and the processing circuitry controls display of an interface for receiving an adjustment of at least one of curl, length, density, and thickness of an appearance of the one or two eyelashes on the 3D image of the user. In an embodiment, the feature is one or more hairs of an eyelash on the 3D image of the user, and the processing circuitry controls display of an interface for receiving an adjustment of at least one of curl, length, density, and thickness of an appearance of the one or more hairs of the eyelash on the 3D image of the user.

In an embodiment, the feature is one or two eyelashes on the 3D image of the user, and the processing circuitry controls display of an interface for receiving an adjustment of at least one of color, texture, and geometric shape of the one or two eyelashes on the 3D image of the user.

In an embodiment, the feature is a lip tone on the 3D image of the user, and the processing circuitry controls display of an interface for receiving an adjustment of a color of the lip tone on the 3D image of the user.

In an embodiment, the interface for receiving the adjustment of the color of the lip tone includes a multi-color palette.

In an embodiment, the feature is a skin tone on the 3D image of the user, and the processing circuitry controls display of an interface for receiving an adjustment of a color of the skin tone on the 3D image of the user.

In an embodiment, the processing circuitry controls transmission of the updated 3D image of the user, the received captured image of the user, and at least one additional captured image of the user to an external system.

In an embodiment, the at least one additional captured image of the user includes an addition or adjustment of the feature on the user itself, and the external system performs a comparison of the at least one additional captured image and the updated 3D image of the user.

In an embodiment, the processing circuitry being further configured to establish a secured protocol and to exchange encrypted and anonymized information with the external system.

In an embodiment, a method is provided that is implemented by a system having processing circuitry, the method comprising: receiving a captured image of a user; generating to a three-dimensional (3D) image of the user based on the captured image of the user; controlling display of an interface for receiving a selection or adjustment of a feature on the 3D image from the user; performing adjustment of the feature on the 3D image based on the received selection or adjustment of the feature of the user to generate an updated 3D image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. A more complete appreciation of the embodiments and many of the attendant advantages thereof will be readily obtained as the same becomes better understood by reference to the following detailed description when considered in connection with the accompanying drawings, wherein:

FIG. 1 shows a system according to an embodiment.

FIGS. 2A-B shows a general process performed at an end-user device according to an embodiment.

FIG. 3 illustrates a process of identifying regions on a 3D avatar for adjusting a particular feature.

FIG. 4 shows a method performed by a system according to an embodiment.

FIG. 5 shows a hardware diagram of an end-user device according to an embodiment.

### DETAILED DESCRIPTION

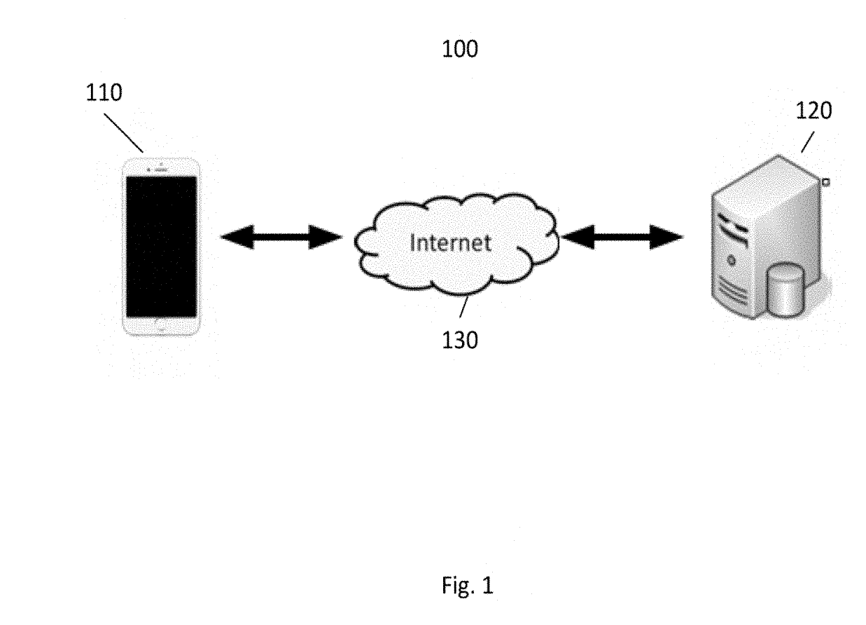

FIG. 1 shows a system 100 in which one or more methodologies or technologies can be implemented such as, for example, virtually displaying cosmetic styles on a user. In an embodiment, the system 100 includes an end user device 110 that is connected to a system 120 via a network 130.

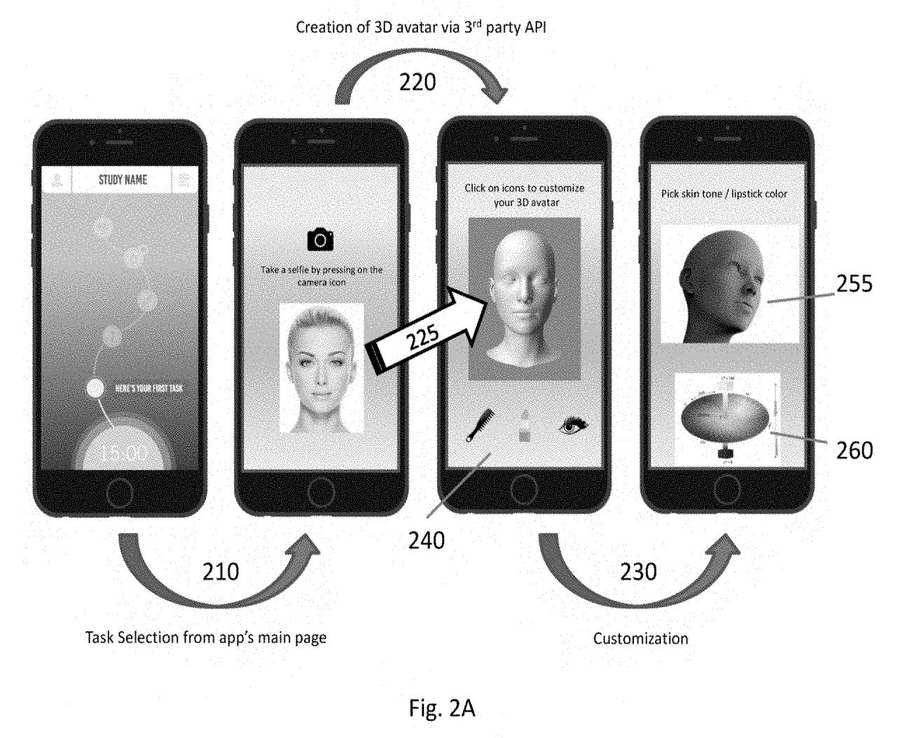

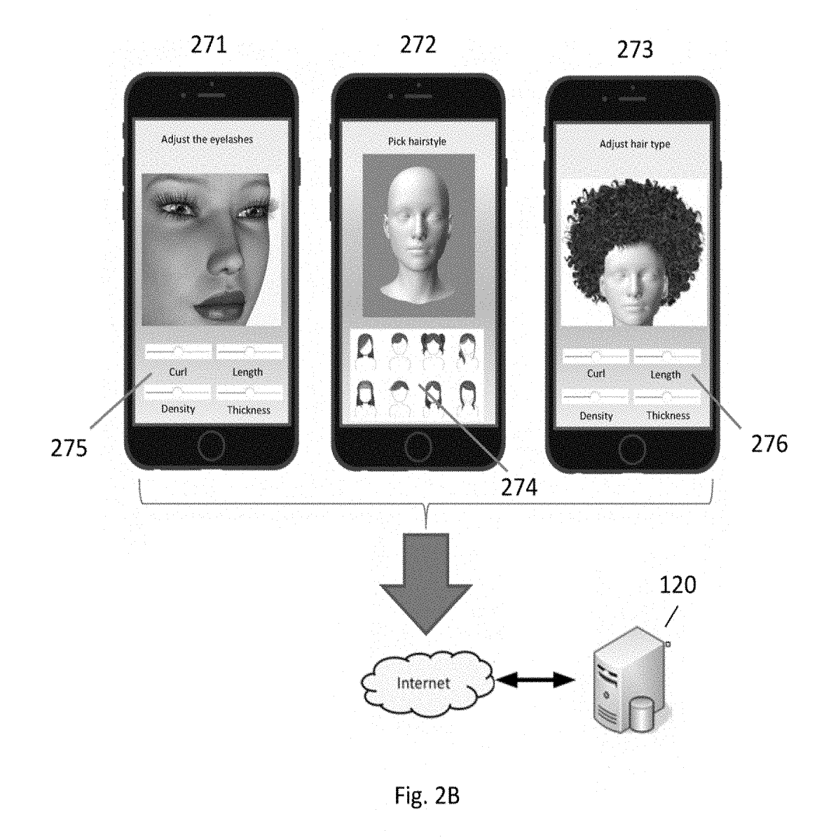

FIGS. 2A-2B illustrate an overall process 200 performed at the end-user device 110 to create a 3D avatar of the user and begin adjustments to a particular feature. In a non-limiting example, the process is performed as part of a research project to determine the effectiveness of the 3D avatar creation process. Therefore, step 210 includes an optional step of a user activating an application on the end-user device that opens up a particular study/research project. The application will prompt the user to perform an initial task of taking a photo of the user itself through the smartphone (i.e., take a “selfie” image). Preferably the selfie image is a portrait of the user's head, face, and neck region as shown in FIG. 2A.

In step 220, the selfie image will be used to create a 3D avatar of the user as shown in 225, which will be described in more detail below. In an embodiment, a 3D avatar is created responsive to user-selected choices from a menu generated based on one or more selfie images. The end-user device 110 may display the results of the 3D avatar creation on a screen that also includes a menu of selection items 240 for a type of feature that will be customized on the 3D avatar. In the example, shown in FIG. 2A, the menu 240 includes an option for customizing features of hair (shown by a comb icon), features of skin tone and lipstick color (shown by the lipstick icon), and features of the user's eyelashes (shown by the eye icon).

In step 230, after receiving the user's selection, a new display screen is generated in step 230 for performing the customization or adjustment of a particular external feature upon the 3D avatar.

The particular example shown in FIG. 2A is for selection of a skin tone or skin color. In this example, a fully rotatable version of the 3D avatar image 255 is presented for the user, in which the user can rotate the image in any direction, and optionally zoom-in or out of the image, to change the perspective or angle/direction of view of the 3D avatar. The user can toggle between adjusting the skin tone or the lipstick color, and then a color palette will be presented for the user to select a specific color to apply to the skin or lip region of the 3D avatar. After the user makes a color selection, the skin or lip region of the 3D avatar will be updated to reflect the user selection.

FIG. 2B shows additional steps in the process, which may include adjustment of the eyelashes 271, and selection/adjustment of a hairstyle 272 and 273.

In step 272, a user may select a predetermine hairstyle from a menu of options as shown in area 274. Following the selection, the user may be presented with the hairstyle adjustment screen in step 273.

For eyelash adjustment, the user may be presented directly with the eyelash adjustment screen shown in step 271. However, if desired, an eyelash style selection screen may be presented prior to step 271 as needed.

With both the adjustment of the eyelashes and the hair type, the curl, length, density, and thickness may be adjusted with a range by one or more slide bars shown in areas 275 and 276, or any other type of variable input mechanism as known in the art.

While not shown in FIGS. 2A-2B, additional features may be selected for completing the 3D avatar. For instance, eye color and eyebrow shape and thickness may be also be selected and adjusted in a similar manner as described above for the previous examples. Alternatively, these features may be captured and incorporated directly into the originally generated 3D avatar based on the selfie image captured by the user.

In an embodiment, a user may select one or more of a predetermine color, texture, geometric shape, and the like to generate a custom eyelashes look from a menu of options generated based on one or more selfie images. In an embodiment, a user may select one or more of a predetermine messages, symbols, natural and unnatural colors, natural and unnatural textures, natural and unnatural geometries, and the like to generate a custom eyelashes look from a menu of options generated based on one or more selfie images.

In step 277, the final avatar together with parameters (values, viewing angles, zoom levels, etc.) selected by consumers is sent back to system 120 via the internet or other network connection for further data analysis and visualization.

As part of the data analysis and visualization, the system 120 may collect additional information for comparison purposes to the 3D avatar. For instance, the system may received the original selfie image captured by the user. Additionally, at a later time when the user actually applies or achieves the desired feature (hairstyle, lipstick color, skin tone, eyelashes, etc.), the user may upload additional selfie images to the system which can then be compared to the generated 3D avatar that was previously received in step 277. Any number of means may be used to generate a score or evaluation of the similarities or differences between the 3D avatar and the actual achieved results of the user.

Furthermore, the external system 120 may perform automated assessment or rating of image features using deep convolutional neural networks. Such an assessment is described in U.S. Pat. No. 9,536,293, which is incorporated herein by reference.

As mentioned above, in step 225, a 3D avatar is created based on a user's “selfie” image. Such a process incorporates processes known in the art for achieving this result.

For instance, there are commercially solutions available to a person of ordinary skill in the art for generating a 3D avatar based on one or more inputted images, such as those by Adobe, Insta3D, my2dselfie, 3DforUS, Seene, usscan360, Loomai, and itsees3D.

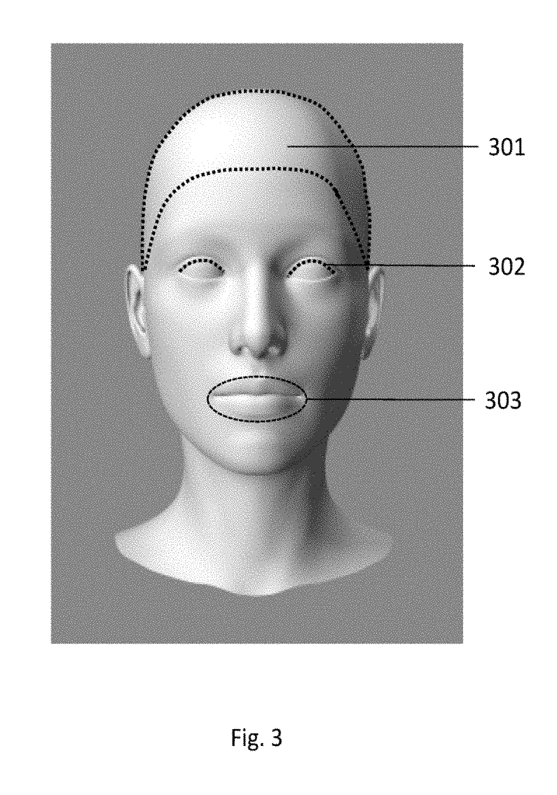

In one example, after the 3D avatar is generated, certain features and locations on the 3D avatar are identified for adjustment or addition of a color or textured feature. In FIG. 3, a region 301 is identified for adding features of a hairstyle. Region 302 is identified for adding eyelashes, and region 303 is identified for changing lip tone. These regions may be identified by image recognition techniques after the 3D avatar is generated. Alternatively, these regions may identified during the rendering process of the original 3D avatar image. In either case, the three-dimensional coordinate points of the surface of each region are identified. Such coordinate points may be similar to a coordinate point system commonly used in computer aided design (CAD) applications, as understood in the art. The identifiable regions are not limited to those shown in FIG. 3, and additional regions may be identified as necessary for adjustment.

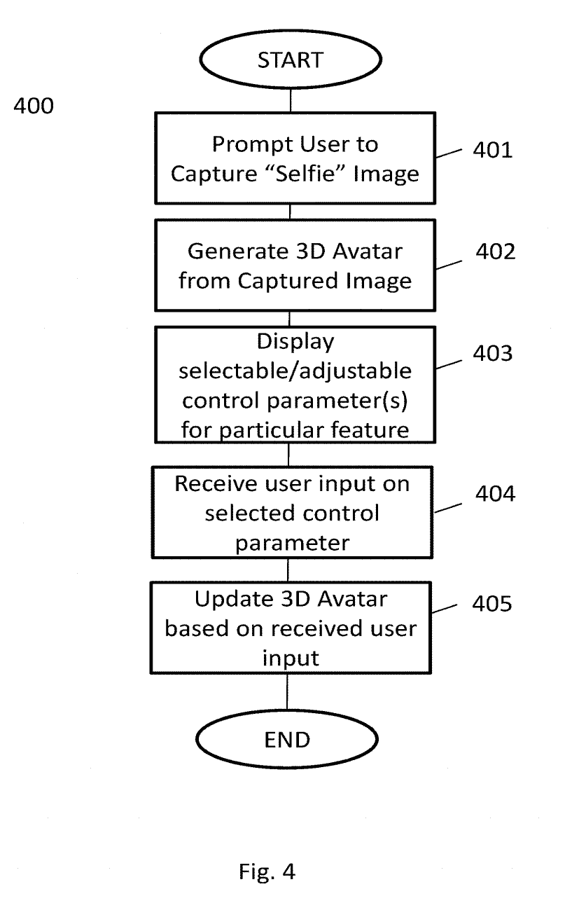

FIG. 4 shows a general process 400 performed in the above-described embodiment by the end-user device 110. In step 410, the user is prompted to capture a “selfie” image. Following capture of the selfie image, in step 420, a 3D avatar image is generated based on the captured selfie image. Following generation of the 3D avatar image, in step 430, adjustable or selectable control parameters may be displayed for the user regarding a particular feature (such as hairstyle, lip/skin tone, or eyelashes). In step 440, the user input is received for the adjustable or selectable control parameter of the particular feature, and in step 450, the 3D avatar is updated to reflect the received user input. The process shown in 400 may be repeated as necessary.

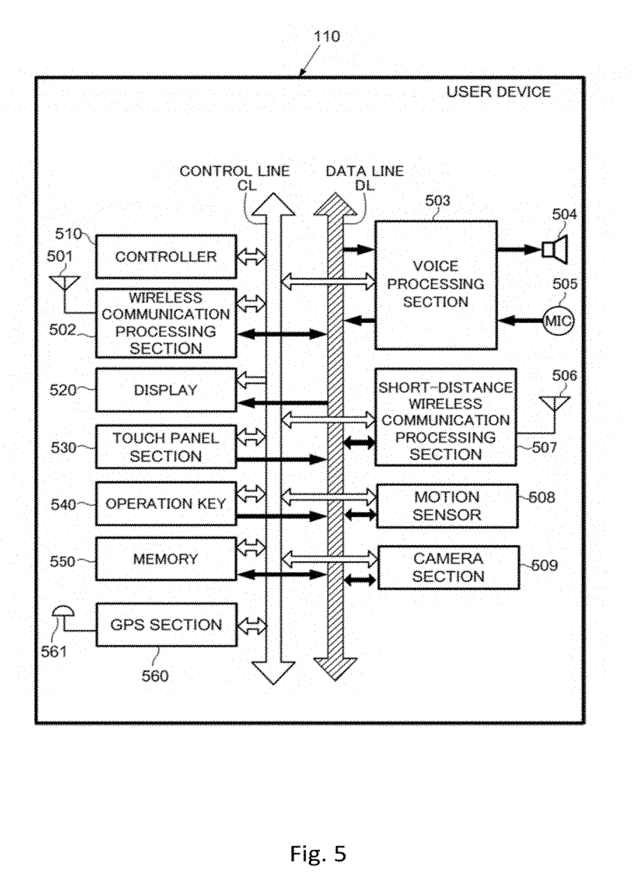

FIG. 5 is a more detailed block diagram illustrating an exemplary user device 110 according to certain embodiments of the present disclosure. In certain embodiments, user device 110 may be a smartphone. However, the skilled artisan will appreciate that the features described herein may be adapted to be implemented on other devices (e.g., a laptop, a tablet, a server, an e-reader, a camera, a navigation device, etc.). The exemplary user device 110 of FIG. 5 includes a controller 510 and a wireless communication processor 502 connected to an antenna 501. A speaker 504 and a microphone 505 are connected to a voice processor 503.

The controller 510 may include one or more Central Processing Units (CPUs), and may control each element in the user device 110 to perform functions related to communication control, audio signal processing, control for the audio signal processing, still and moving image processing and control, and other kinds of signal processing. The controller 510 may perform these functions by executing instructions stored in a memory 550. Alternatively or in addition to the local storage of the memory 550, the functions may be executed using instructions stored on an external device accessed on a network or on a non-transitory computer readable medium.

The memory 550 includes but is not limited to Read Only Memory (ROM), Random Access Memory (RAM), or a memory array including a combination of volatile and non-volatile memory units. The memory 550 may be utilized as working memory by the controller 510 while executing the processes and algorithms of the present disclosure.

Additionally, the memory 550 may be used for long-term storage, e.g., of image data and information related thereto.

The user device 110 includes a control line CL and data line DL as internal communication bus lines. Control data to/from the controller 510 may be transmitted through the control line CL. The data line DL may be used for transmission of voice data, display data, etc.

The antenna 501 transmits/receives electromagnetic wave signals between base stations for performing radio-based communication, such as the various forms of cellular telephone communication. The wireless communication processor 502 controls the communication performed between the user device 110 and other external devices via the antenna 501. For example, the wireless communication processor 502 may control communication between base stations for cellular phone communication.

The speaker 504 emits an audio signal corresponding to audio data supplied from the voice processor 1503. The microphone 505 detects surrounding audio and converts the detected audio into an audio signal. The audio signal may then be output to the voice processor 503 for further processing. The voice processor 503 demodulates and/or decodes the audio data read from the memory 550 or audio data received by the wireless communication processor 502 and/or a short-distance wireless communication processor 507. Additionally, the voice processor 503 may decode audio signals obtained by the microphone 505.

The exemplary user device 110 may also include a display 520, a touch panel 530, an operation key 540, and a short-distance communication processor 507 connected to an antenna 506. The display 520 may be a Liquid Crystal Display (LCD), an organic electroluminescence display panel, or another display screen technology. In addition to displaying still and moving image data, the display 520 may display operational inputs, such as numbers or icons which may be used for control of the user device 110. The display 520 may additionally display a GUI for a user to control aspects of the user device 110 and/or other devices. Further, the display 520 may display characters and images received by the user device 110 and/or stored in the memory 550 or accessed from an external device on a network. For example, the user device 110 may access a network such as the Internet and display text and/or images transmitted from a Web server.

The touch panel 530 may include a physical touch panel display screen and a touch panel driver. The touch panel 530 may include one or more touch sensors for detecting an input operation on an operation surface of the touch panel display screen. The touch panel 130 also detects a touch shape and a touch area. In an embodiment, “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 530 may detect when the stylus approaches/contacts the operation surface of the touch panel display (similar to the case in which a finger is used for the touch operation).

In certain aspects of the present disclosure, the touch panel 530 may be disposed adjacent to the display 520 (e.g., laminated) or may be formed integrally with the display 520. For simplicity, the present disclosure assumes the touch panel 530 is formed integrally with the display 520 and therefore, examples discussed herein may describe touch operations being performed on the surface of the display 520 rather than the touch panel 530. However, the skilled artisan will appreciate that this is not limiting.

For simplicity, the present disclosure assumes the touch panel 530 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 530 may include transparent electrode touch sensors arranged in the X-Y direction on the surface of transparent sensor glass.

The touch panel driver may be included in the touch panel 530 for control processing related to the touch panel 530, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 130 may detect a position of a user's finger around an edge of the display panel 120 (e.g., gripping a protective case that surrounds the display/touch panel). Signals may be transmitted by the touch panel driver, e.g. in response to a detection of a touch operation, in response to a query from another element based on timed data exchange, etc.

The touch panel 530 and the display 520 may be surrounded by a protective casing, which may also enclose the other elements included in the user device 110. In certain embodiments, a position of the user's fingers on the protective casing (but not directly on the surface of the display 520) may be detected by the touch panel 130 sensors. Accordingly, the controller 510 may perform display control processing described herein based on the detected position of the user's fingers gripping the casing. For example, an element in an interface may be moved to a new location within the interface (e.g., closer to one or more of the fingers) based on the detected finger position.

Further, in certain embodiments, the controller 510 may be configured to detect which hand is holding the user device 110, based on the detected finger position. For example, the touch panel 530 sensors may detect a plurality of fingers on the left side of the user device 110 (e.g., on an edge of the display 520 or on the protective casing), and detect a single finger on the right side of the user device 110. In this exemplary scenario, the controller 510 may determine that the user is holding the user device 110 with his/her right hand because the detected grip pattern corresponds to an expected pattern when the user device 110 is held only with the right hand.

The operation key 540 may include one or more buttons or similar external control elements, which may generate an operation signal based on a detected input by the user. In addition to outputs from the touch panel 130, these operation signals may be supplied to the controller 510 for performing related processing and control. In certain aspects of the present disclosure, the processing and/or functions associated with external buttons and the like may be performed by the controller 510 in response to an input operation on the touch panel 530 display screen rather than the external button, key, etc. In this way, external buttons on the user device 110 may be eliminated in lieu of performing inputs via touch operations, thereby improving water-tightness.

The antenna 506 may transmit/receive electromagnetic wave signals to/from other external apparatuses, and the short-distance wireless communication processor 507 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 507.

The user device 20 may include a motion sensor 508. The motion sensor 508 may detect features of motion (i.e., one or more movements) of the user device 110. For example, the motion sensor 508 may include an accelerometer to detect acceleration, a gyroscope to detect angular velocity, a geomagnetic sensor to detect direction, a geo-location sensor to detect location, etc., or a combination thereof to detect motion of the user device 110. The motion sensor 508 can work in conjunction with a Global Positioning System (GPS) section 560. The GPS section 560 detects the present position of the device 110. The information of the present position detected by the GPS section 560 is transmitted to the controller 510. An antenna 561 is connected to the GPS section 560 for receiving and transmitting signals to and from a GPS satellite.

The user device 110 may include a camera section 509, which includes a lens and shutter for capturing photographs of the surroundings around the user device 110. In an embodiment, the camera section 509 captures surroundings of an opposite side of the user device 110 from the user. The images of the captured photographs can be displayed on the display panel 520. A memory section saves the captured photographs. The memory section may reside within the camera section 509 or it may be part of the memory 550. The camera section 509 can be a separate feature attached to the user device 110 or it can be a built-in camera feature.

While not shown in detail, the system 130 shown in FIG. 1 may have similar hardware features as those shown in FIG. 5.

The end-user device is configured to upload data regarding the user to the system 120. Such data may include a user profile. The client device can also provide an option to keep the user data anonymous.

The end-user device 110 can use the camera function to provide a sharing feature, in which the user can upload photos taken before and/or after the use of any cosmetic products o appliances. The uploaded photos can be used for receiving feedback from professionals in the skin (or hair) treatment industry or other users. In an embodiment, the uploaded photos may be uploaded directly to a social media platform.

Furthermore, the circuitry the end user device 110 may be configured to actuate a discovery protocol that allows the end user device 110 and the system 120 to identify each other and to negotiate one or more pre-shared keys, which further allows the end user device 110 and the system 120 to exchanged encrypted and anonymized information.

Numerous modifications and variations of the present invention are possible in light of the above teachings. It is therefore to be understood that within the scope of the appended claims, the invention may be practiced otherwise than as specifically described herein.

What is claimed is:

1. A system comprising:
processing circuitry configured to
receive a captured image of a user;
generate a three-dimensional (3D) image of the user based on the captured image of the user;
control display of an interface for receiving a selection or adjustment of a feature on the 3D image from the user; and
perform adjustment of the feature on the 3D image based on the received selection or adjustment of the feature of the user to generate an updated 3D image.

2. The system according to claim 1, wherein the feature is a hairstyle of the 3D image of the user, and the processing circuitry controls display of an interface for receiving a selection of a predetermined hairstyle from the user.

3. The system according to claim 2, wherein when the predetermined hairstyle is selected by the user, the processing circuitry controls display of an interface for receiving an adjustment of at least one of curl, length, density, and thickness of an appearance of the hair in the selected predetermined hairstyle.

4. The system according to claim 1, wherein the feature is one or two eyelashes on the 3D image of the user, and the processing circuitry controls display of an interface for receiving an adjustment of at least one of curl, length, density, and thickness of an appearance of the one or two eyelashes on the 3D image of the user.

5. The system according to claim 1, wherein the feature is a lip tone on the 3D image of the user, and the processing circuitry controls display of an interface for receiving an adjustment of a color of the lip tone on the 3D image of the user.

6. The system according to claim 5, wherein the interface for receiving the adjustment of the color of the lip tone includes a multi-color palette.

7. The system according to claim 1, wherein the feature is a skin tone on the 3D image of the user, and the processing circuitry controls display of an interface for receiving to an adjustment of a color of the skin tone on the 3D image of the user.

8. The system according to claim 1, wherein the processing circuitry controls transmission of the updated 3D image of the user, the received captured image of the user, and at least one additional captured image of the user to an external system.

9. The system according to claim 9, wherein the at least one additional captured image of the user includes an addition or adjustment of the feature on the user itself, and the external system performs a comparison of the at least one additional captured image and the updated 3D image of the user.

10. The system according to claim 9, the processing circuitry being further configured to establish a secured protocol and to exchange encrypted and anonymized information with the external system.

11. A method, implemented by a system having processing circuitry, comprising:
receiving a captured image of a user;
generating a three-dimensional (3D) image of the user based on the captured image of the user;
controlling display of an interface for receiving a selection or adjustment of a feature on the 3D image from the user;
performing adjustment of the feature on the 3D image based on the received selection or adjustment of the feature of the user to generate an updated 3D image.

12. The method according to claim 11, wherein the feature is a hairstyle of the 3D image of the user, and the method includes controlling display of an interface for receiving a selection of a predetermined hairstyle from the user.

13. The method according to claim 12, wherein when the predetermined hairstyle if selected by the user, the method includes controlling display of an interface for receiving an adjustment of at least one of curl, length, density, and thickness of an appearance of the hair in the selected predetermined hairstyle.

14. The method according to claim 11, wherein the feature is one or two eyelashes on the 3D image of the user, and the method includes controlling display of an interface for receiving an adjustment of at least one of curl, length, density, and thickness of an appearance of the one or two eyelashes on the 3D image of the user.

15. The method according to claim 11, wherein the feature is a lip tone on the 3D image of the user, and the method includes controlling display of an interface for receiving an adjustment of a color of the lip tone on the 3D image of the user.

16. The method according to claim 15, wherein the interface for receiving the adjustment of the color of the lip tone includes a multi-color palette.

17. The method according to claim 11, wherein the feature is a skin tone on the 3D image of the user, and the method includes controlling display of an interface for receiving an adjustment of a color of the skin tone on the 3D image of the user.

18. The method according to claim 11, wherein the method includes controlling transmission of the updated 3D image of the user, the received captured image of the user, and at least one additional captured image of the user to an external system.

19. The method according to claim 19, wherein the at least one additional captured image of the user includes an addition or adjustment of the feature on the user itself, and the external system performs a comparison of the at least one additional captured image and the updated 3D image of the user.

20. The method according to claim 19, wherein the method includes establishing a secured protocol and to exchange encrypted and anonymized information with the external system.
